(19) United States
(12) Patent Application Publication
(10) Pub. No.: US 2016/0154664 A1
(43) Pub. Date: Jun. 2, 2016

(54) INFORMATION PROCESSING SYSTEM AND METHOD OF CONTROLLING SAME

(71) Applicant: FUJITSU LIMITED, Kawasaki-shi (JP)

(72) Inventor: Noboru Iwamatsu, Kawasaki (JP)

(73) Assignee: FUJITSU LIMITED, Kawasaki-shi (JP)

(21) Appl. No.: 14/923,118

(22) Filed: Oct. 26, 2015

(30) Foreign Application Priority Data
Dec. 2, 2014 (JP) 2014-243835

(51) Int. Cl. G06F 9/455

(52) U.S. Cl. CPC G06F 9/45558; G06F 2009/45575

(57) ABSTRACT

An information processing system includes a plurality of information processing devices and a management device that manages the plurality of information processing devices. A first information processing device among the plurality of information processing devices includes a first booting unit that boots a virtual machine a reboot detecting unit that detects reboot of the virtual machine and a destroying unit that destroys the virtual machine in response to detection of the reboot. A second information processing device among the plurality of information processing devices includes a second booting unit that boots the destroyed virtual machine upon receiving an boot instruction to boot the destroyed virtual machine after the virtual machine of the first information processing device is destroyed.

### CROSS-REFERENCE TO RELATED APPLICATION

This application is based upon and claims the benefit of priority of the prior Japanese Patent Application No. 2014-243835, filed on Dec. 2, 2014, the entire contents of which are incorporated herein by reference.

### FIELD

The present invention relates to an information processing system and a method of controlling the same.

### BACKGROUND

According to a virtualization technique, a hypervisor operating on an information processing device which is a computer or a physical machine (hereinafter, the information processing device will be also referred to as a computer or a physical machine, or simply as a host machine or a host) emulates hardware of a physical machine and boots and creates a plurality of virtual machines (VMs) on the physical machine. The virtualization technique creates a plurality of virtual machines on a plurality of physical machines to realize a service system for a plurality of users. A physical machine on which a virtual machine is booted and created is also referred to as a host machine or simply as a host.

In such a virtualization technique, a live migration of migrating a virtual machine from a migration source host to a migration destination host is needed when performing maintenance of a physical machine and concentrating virtual machines on another physical machine. A live migration is a technique of migrating a virtual machine from one physical machine to another physical machine while maintaining the operating state of the virtual machine. The use of the live migration enables virtual machines to migrate to another physical machine without suspending a service system constructed by the virtual machines.

The virtualization technique is disclosed in Japanese Laid-open Patent Publication No. 2011-248616, No. 2011-118557, No. 10-283210 and No. 2004-133894.

### SUMMARY

A live migration of virtual machines includes (1) transmitting a memory content of a virtual machine in operation in a migration source host to a migration destination host, (2) transmitting a memory content changed during the transmission, the context which is CPU register information, a hardware emulation state including I/O states, and the like to the migration destination host while pausing the virtual machine on the migration source host, and (3) resuming the virtual machine on the migration destination host.

Thus, memory content transmission time is longer and therefore a load on a network between the hosts is increased. In particular, in a virtual machine in which data is frequently rewritten to a memory, the time taken for memory content transmission increases, and it is difficult to predict the transmission time due to occurrence of retransmission of modified data (dirty pages). Further, in a large-scale cloud system in which a large number of virtual machines are booted on a large number of host machines, a live migration of virtual machines for maintenance of host machines needs a long period and consumes a large network bandwidth.

Moreover, in a live migration, when a hypervisor of a migration source host has a different version from a migration destination host, the migration may fail due to some reasons such as the inability of a migration destination host to inherit a hardware emulation state in a migration source host.

In order to improve the live migration, a method of compressing a memory content to shorten the memory content transmission time has been proposed. However, since compression of memory content increases the CPU usage rate, it is difficult to obtain such an improvement effect as expected. Moreover, transmitting the memory content of a virtual machine to a migration destination host in advance is a waste of the memory resources of the migration destination host and is not desirable.

An information processing system comprises: a plurality of information processing devices; and a management device that manages the plurality of information processing devices, wherein a first information processing device among the plurality of information processing devices includes: an booting unit configured to boot a virtual machine; a reboot detecting unit configured to detect reboot of the virtual machine; and a destroying unit configured to destroy the virtual machine in response to detection of the reboot, and a second information processing device among the plurality of information processing devices includes: an booting unit configured to boot the destroyed virtual machine upon receiving a boot instruction to boot the destroyed virtual machine after the virtual machine of the first information processing device is destroyed.

According to the first aspect, virtual machines are migrated quickly and reliably without impairing user's convenience of virtual machines.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information processing system according to the present embodiment.

FIG. 2 is a diagram illustrating a schematic configuration of the hosts 1, 2, and 3, the management server 4, and the software update service sever 5 illustrated in FIG. 1.

FIG. 3 is a diagram illustrating a configuration of the shared storage 20 illustrated in FIG. 1.

FIG. 4 is a table illustrating some commands of a hypervisor and the processing contents thereof.

FIG. 5 is a flowchart illustrating a live migration process.

FIG. 6 is a flowchart illustrating a migration process triggered by a reboot in the present embodiment.

FIG. 7 is a sequence diagram illustrating the migration process triggered by a reboot in the present embodiment.

FIG. 8 is a sequence diagram illustrating the migration process triggered by a reboot in the present embodiment.

FIG. 9 is a flowchart illustrating a modified example of a migration process triggered by a reboot according to the present embodiment.

FIG. 10 is a flowchart illustrating a virtual machine reboot operation and a detection process thereof according to the present embodiment.

FIG. 11 is a diagram illustrating an example of a process table in the event of reboot detection set to the RDM management module RDM_M according to the present embodiment.

FIG. 12 is a flowchart illustrating a migration process triggered by a reboot according to the second embodiment.

FIG. 13 is a flowchart illustrating a migration process triggered by a reboot according to the second embodiment.

FIG. 14 is a flowchart illustrating a migration process triggered by a reboot according to the second embodiment.

FIG. 15 is a diagram illustrating an example of the migration plan table according to the second embodiment.

FIG. 16 is a flowchart illustrating a migration process triggered by a reboot according to the third embodiment.

FIG. 17 is a flowchart illustrating a migration process triggered by a reboot according to the third embodiment.

FIG. 18 is a flowchart illustrating a migration process triggered by a reboot according to the third embodiment.

FIG. 19 is a diagram illustrating an example of a migration plan table according to the third embodiment.

### DESCRIPTION OF EMBODIMENTS

In the following description, it will be appropriately expressed that software installed in a physical machine which is an information processing device executes a function of the software. To express exactly, such an operation means that the physical machine executes the software whereby a certain function of the software is executed. However, in the following description, sometimes, it will be simply expressed that software executes its function.

[Information Processing System of Present Embodiment]

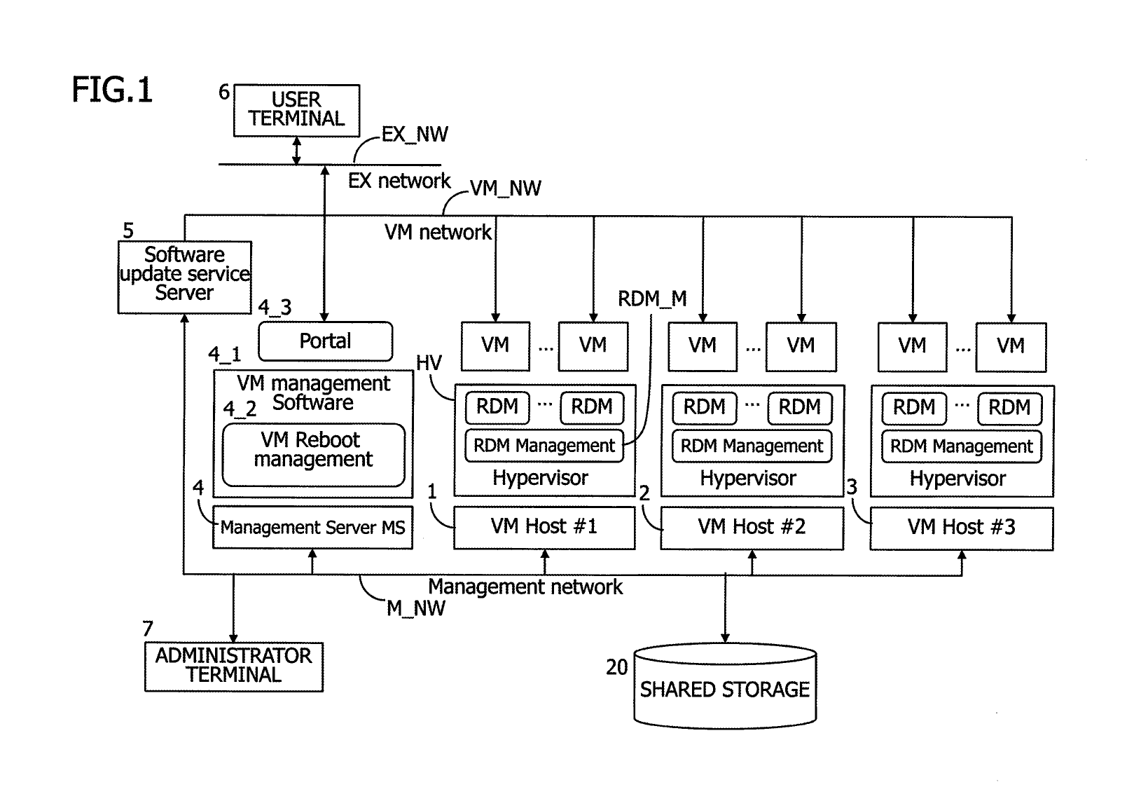

FIG. 1 is a diagram illustrating a configuration of an information processing system according to the present embodiment. The information processing system includes a plurality of physical machines (hosts) 1, 2, and 3 which each execute a virtual machine VM on a hypervisor HV, a management server (MS) 4 that manages virtual machines, and a shared storage 20.

Each of the hosts 1, 2, and 3 executes the hypervisor HV to boot and execute one or a plurality of virtual machines VMs. In another expression, the hypervisor HV boots and executes the virtual machine VM. The shared storage 20 stores image files such as a guest operating system (OS) and an application program of the virtual machine VM. The virtual machine VM executes the guest OS and the application program in the image files stored in the shared storage 20 to construct a desired service system.

VM management software 4_1 of the management server 4 causes the hypervisor HV to boot a virtual machine based on configuration information and to pause, resume, and destroy the virtual machine as appropriate. Moreover, the VM management software 4_1 of the management server 4 collects an operation state of a virtual machine from the hypervisor HV and causes the virtual machine to migrate to another physical machine from a physical machine in operation as appropriate. Further, the VM management software 4_1 of the management server 4 provides a portal site to a user terminal 6 of a service system constructed by virtual machines so that the user terminal 6 of the service system performs maintenance of the service system.

The hosts 1, 2, and 3, the management server 4, and the shared storage 20 communicates with each other via a management network M_NW. The user terminal 6 accesses a portal site 4_3 of a cloud computing service provided by the management server 4 via an external network EX_NW. Further, an administrator terminal 7 of the information processing system can access the management server 4 via the management network M_NW, for example. Moreover, the respective virtual machines VMs communicate with each other via a VM network VM_NW. In FIG. 1, although the VM network VM_NW is connected directly to the respective virtual machines VMs, the virtual machine VM is actually connected to the VM network VM_NW via network interfaces of the hosts 1, 2, and 3.

The information processing system illustrated in FIG. 1 includes a software update service sever 5. The software update service sever 5 issues instructions to apply updates of the software of the hosts 1, 2, and 3 in the information processing system and the software of the virtual machines VMs in the information processing system. The administrator terminal 7 that manages the information processing system sets schedules for software updates to the software update service sever 5, so as to execute application of the updates for the software in the information processing system according to the schedules.

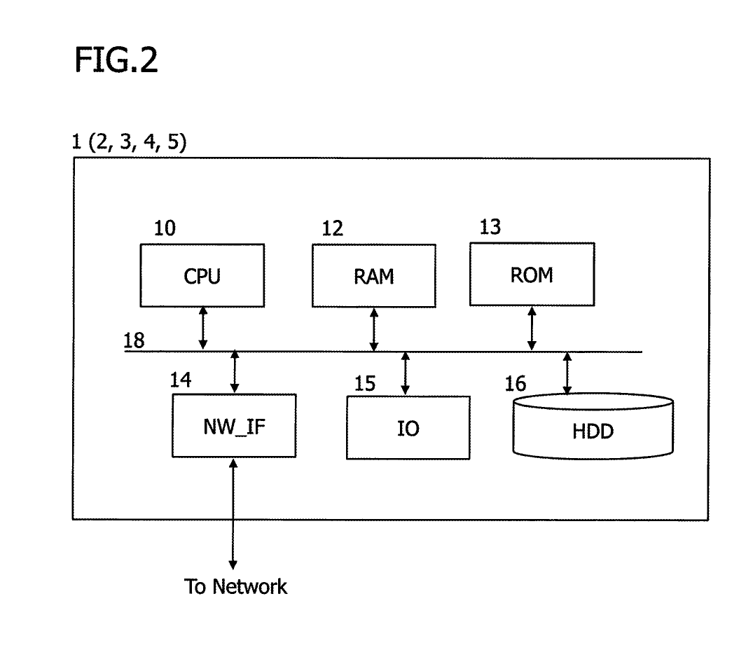

FIG. 2 is a diagram illustrating a schematic configuration of the hosts 1, 2, and 3, the management server 4, and the software update service sever 5 illustrated in FIG. 1. For example, the hosts 1, 2, and 3 each include a CPU 10 which is an arithmetic processing unit, a RAM 12, a ROM 13, a network interface (for example, a network interface card (NIC)) 14, an input/output unit 15, and a large-capacity storage device 16 such as a hard disk, which are connected by a bus 18.

The large-capacity storage device 16 of the hosts 1, 2, and 3 stores an OS, a hypervisor HV, and the like, for example. The large-capacity storage device 16 of the management server 4 stores an OS, VM management software 4_1, and the like, for example. Moreover, the large-capacity storage device 16 of the software update service sever 5 stores an OS, a software update service program, and the like, for example. Moreover, the OS and the software stored in the large-capacity storage device 16 are loaded into the RAM and are executed by the CPU.

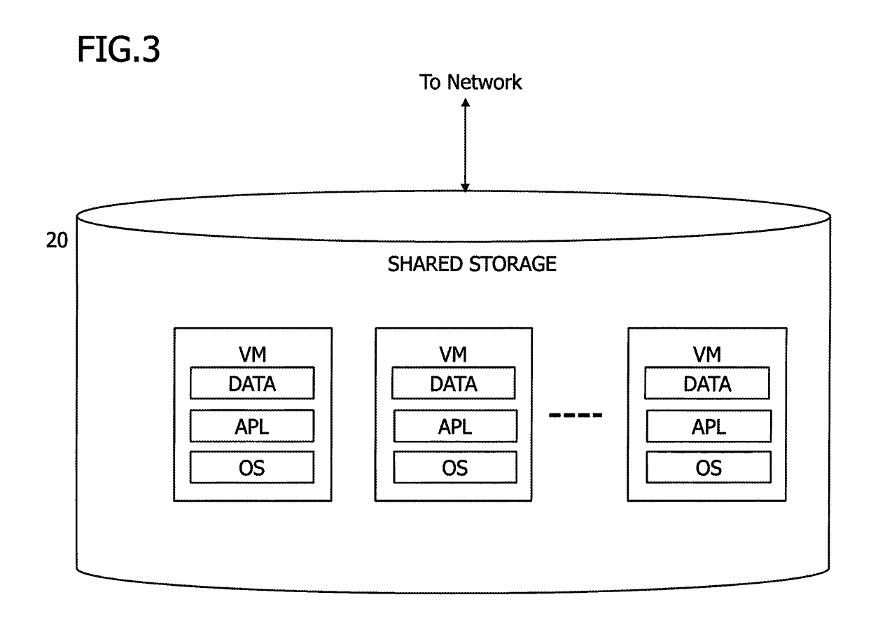

FIG. 3 is a diagram illustrating a configuration of the shared storage 20 illustrated in FIG. 1. The shared storage 20 stores the image files of the virtual machines VMs created in the VM hosts 1, 2, and 3. The image file of the virtual machine VM includes a guest OS, an application APL, various types of data DATA, and the like, for example. The data DATA includes a hardware emulation state including the I/O state, for example.

The hypervisor HV of each of the VM hosts 1, 2, and 3 boots a virtual machine corresponding to the image file in the shared storage 20 to execute a virtual machine VM in response to a command to create a virtual machine VM from the VM management software 4_1 of the management server 4.

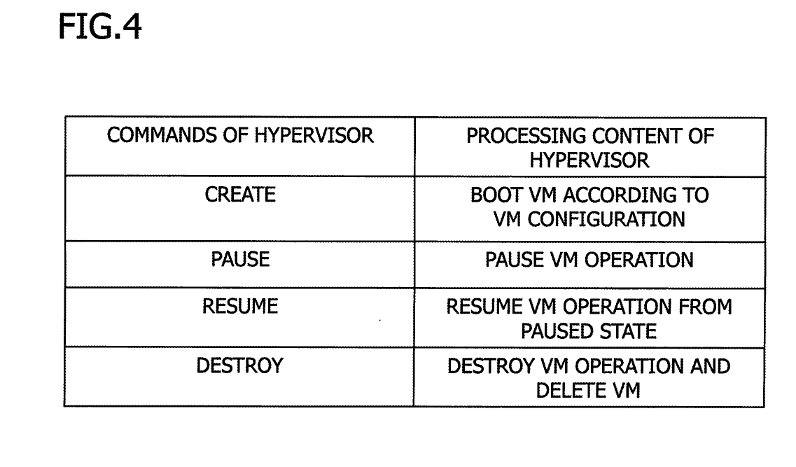

FIG. 4 is a table illustrating some commands of a hypervisor and the processing contents thereof. The hypervisor HV of each of the VM hosts 1, 2, and 3 executes the processes illustrated in FIG. 4 in response to a command from the VM management software 4_1 or the like of the management server 4. The process related to a create command (or an boot command) is a process of booting a virtual machine VM according to configuration information of the virtual machine VM. A virtual machine VM is created by booting the virtual machine VM on a VM host.

The configuration information of a virtual machine VM is described in a configuration file of a virtual machine managed by the VM management software 4_1. The configuration file of the virtual machine includes the number of CPUs or CPU cores used by the virtual machine, a CPU usage rate, a memory usage rate, a network bandwidth, and the like, for example. The management server 4 transmits a create command to a hypervisor HV of a VM host by attaching the configuration file of the virtual machine thereto (or indicating the path information of the configuration file).

The process related to a pause command is a process of pausing an operation of a virtual machine VM. When the pause command is issued, although a virtual machine VM still uses the resources such as a memory area, the control of virtualization by a hypervisor HV stops and the execution or the like of an application by the virtual machine VM stops. The process related to a resume command is a process of resuming the paused operation of a virtual machine VM. Moreover, the process related a destroy command is a process of destroying an operation of a virtual machine VM and deleting a virtual machine VM having been created on a VM host. When the destroy command is issued, the data in a memory having been used by the virtual machine VM and information on the commands in the CPU are saved in the image file in the shared storage 20 as appropriate.

[Live Migration]

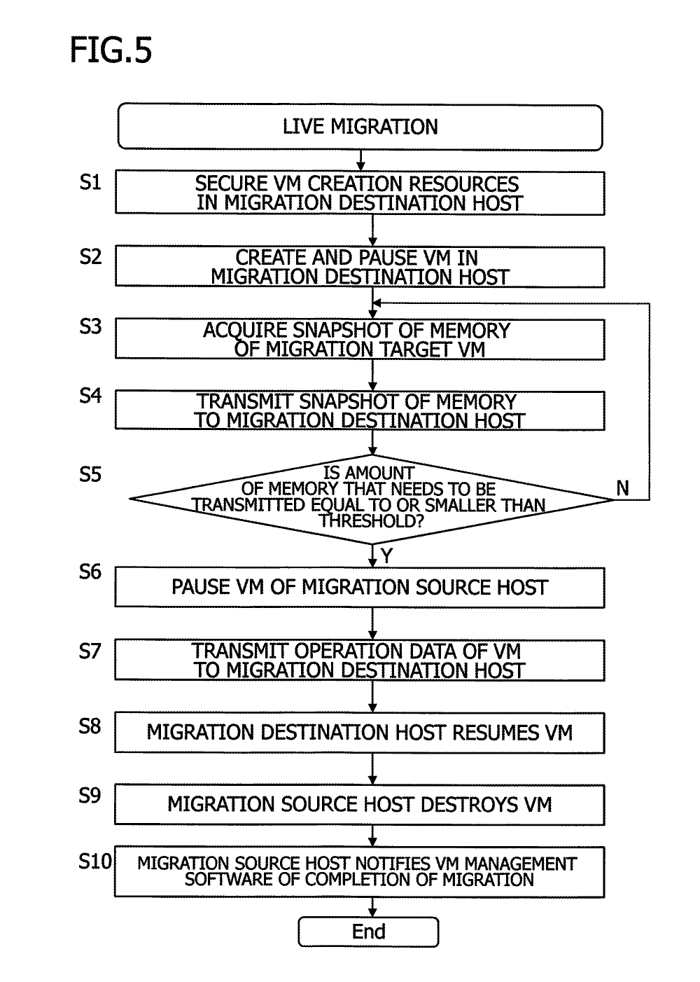

FIG. 5 is a flowchart illustrating a live migration process. It is assumed that a virtual machine VM has been booted on a migration source host and has been in operation. Thus, first, the VM management software 4_1 of the management server 4 secures hardware resources such as resources, a CPU, a memory capacity, and a network bandwidth needed for allowing a migration destination host to create a virtual machine VM (S1). The VM management software 4_1 of the management server 4 collects the operation information of the virtual machine VM from the hypervisor HV and manages the hardware resources of each host. Thus, the VM management software 4_1 reserves the resources of a migration destination host used by the migration source virtual machine based on the managed hardware resources.

Subsequently, the VM management software 4_1 boots a migration target virtual machine VM on the migration destination host and puts the virtual machine into a pause state (S2). This process is performed in such a way that the VM management software 4_1 of the management server 4 causes a hypervisor HV of the migration destination host to execute a create command and then execute a pause command.

After that, the hypervisor HV of the migration source host acquires a snapshot (current data) of a memory area being used by the migration target virtual machine VM (S3) and transmits the acquired snapshot to the memory of the migration destination host (S4). The memory data is transmitted continuously until the amount of memory data that needs to be transmitted becomes equal to or smaller than a threshold (S5). When the amount of memory data is not equal to or smaller than the threshold, the hypervisor HV of the migration source host transmits dirty pages written to the memory of the migration source host during transmission of the snapshot to the memory of the migration destination host after the transmission of the snapshot ends.

When the amount of memory data that needs to be transmitted becomes equal to or smaller than the threshold (S5: YES), the hypervisor HV of the migration source host pauses the virtual machine VM of the migration source host and transmits the operation data of the virtual machine in the CPU and the memory of the migration source host to the migration destination host (S7). As a result, the virtual machine VM of the migration destination host has the same operation state as the virtual machine of the migration source host. After that, the hypervisor HV of the migration destination host resumes the virtual machine VM in the pause state (S8). At the same time, the hypervisor HV of the migration source host destroys the migration target virtual machine VM and sends a notification of completion of migration of the virtual machine to the VM management software 4_1 of the management server 4 (S10).

As described above, in a live migration, the same virtual machine VM as that of the migration source host is booted on the migration destination host without destroying the virtual machine VM of the migration source host. The operation of the virtual machine VM is stopped for a very short period until the virtual machine VM is booted on the migration destination host in step S8 after the virtual machine VM of the migration source host is paused in step S6. Thus, the virtual machine VM migrates from the migration source host to the migration destination host without stopping its operation substantially.

However, this live migration has the following problems. A first problem is that a large network bandwidth is consumed since the snapshot of the memory area of a migration source host is transmitted to the memory of a migration destination host. Further, when the volume of the memory data to be transmitted increases, the transmission time also increases. In particular, in a virtual machine VM in which data is frequently rewritten to a memory, it is difficult to predict the time taken until the volume of the memory data to be transmitted reaches a threshold or smaller. Thus, in a large-scale cloud system in which a large number of virtual machines are created and executed on a large number of hosts, maintenance of hosts needs a long period and consumes a large network bandwidth.

A second problem is that, when a hypervisor HV of a migration source host has a different version from a hypervisor HV of a migration destination host, even if a virtual machine VM is booted on the migration destination host, the virtual machine VM does not operate properly, and the live migration may fail. One example of the causes of the failure is a case in which the memory area for storing an operation state is different due to a difference in hypervisor version, and the operation state of a virtual machine in a migration source host is not able to be inherited to a migration destination host.

[Migration in Present Embodiment]

Returning to FIG. 1, the hypervisor HV of each of the VM hosts 1, 2, and 3 has a reboot detection module (RDM) (or reboot detection module) that detects a software reboot (hereinafter referred to simply as a soft reboot) of a virtual machine VM in addition to general functions such as creation and destruction of virtual machines VMs. A soft reboot process of a virtual machine VM has a process of allowing a guest OS of a virtual machine VM to call a reboot routine using a BIOS call. Thus, a soft reboot of virtual machines is detected by providing a reboot detection module RDM of a hypervisor HV with a function of detecting the call of a reboot routine based on a BIOS call. In general, although a hypervisor detects an boot command or a destroy command for virtual machines, the hypervisor does not detect a soft reboot of virtual machines since the soft reboot is an operation during operation of a virtual machine. Thus, the present embodiment provides the hypervisor HV with a function of detecting a soft reboot of virtual machines.

Further, the hypervisor HV has a RDM management module RDM_M that destroys a reboot target virtual machine VM in response to detection of a soft reboot by the reboot detection module RDM and notifies the management server 4 of the destruction of the virtual machine.

Moreover, the VM management software 4_1 of the management server 4 has a VM reboot management module 4_2 in addition to a general VM management function. The VM reboot management module 4_2 enables a reboot detection module RDM of a migration target virtual machine VM and sets processes before and after a reboot of a virtual machine VM is detected to a RDM management module RDM_M of a hypervisor HV so that a VM host is changed using a soft reboot of a virtual machine VM as a trigger.

Moreover, the software update service sever 5 provides and applies an OS software updater to a virtual machine VM in operation. For example, the VM management software 4_1 of the management server 4 sets schedules for OS software updates for a migration target virtual machine VM in the information processing system illustrated in FIG. 1 to the software update service sever 5. Based on the set schedules, the software update service sever 5 notifies the migration target virtual machine VM of the application of OS software updates. In response to the update application notification, when the user terminal 6 of the virtual machine VM operates to reboot the virtual machine VM, the virtual machine VM is rebooted in response to the operation of the soft reboot.

In the present embodiment, the reboot detection module RDM of the hypervisor HV detects the reboot of the virtual machine VM and notifies the RDM management module RDM_M of the reboot. Using this reboot as a trigger, the RDM management module RDM_M destroys the migration target virtual machine VM on the migration source host and notifies the VM reboot management module 4_2 of the VM management server 4 of the destruction of the virtual machine. In response to the notification, the VM reboot management module 4_2 instructs the hypervisor HV of the migration destination host to boot the destroyed virtual machine VM so that the destroyed virtual machine is booted.

Instead of the VM reboot management module 4_2, the RDM management module RDM_M in the hypervisor HV may directly notify the hypervisor HV of the migration destination host of the boot of the destroyed virtual machine VM so that the destroyed virtual machine is booted.

Moreover, it is preferable that the RDM management module RDM_M has a setting for distinguishing a migration target virtual machine from a non-migration target virtual machine. By referring to such a setting, when a reboot of a virtual machine is detected and the virtual machine is a migration target virtual machine, the RDM management module RDM_M causes the virtual machine to be booted on another host rather than booting the virtual machine on the same host. When the virtual machine is a non-migration target virtual machine, the virtual machine is booted on the same host similarly to a normal reboot.

As described above, in the present embodiment, a migration of virtual machines is executed in such a way that, when the hypervisor HV detects a soft reboot of a migration target virtual machine VM, the migration target virtual machine VM on the migration source host is destroyed, and the migration target virtual machine VM is booted on a migration destination host. That is, unlike a live migration, in the present embodiment, a cold migration is executed upon detecting a timing of a reboot of a virtual machine, and the virtual machine is migrated to another host.

As means for causing a reboot of a virtual machine, a forced soft reboot of a migration target virtual machine VM caused by the administrator terminal 7 of the information processing system and an arbitrary soft reboot caused by the user terminal 6 of a virtual machine may be used in addition to a soft reboot accompanied by the OS software update. The forced soft reboot of a migration target virtual machine caused by the administrator terminal 7 is executed when a soft reboot command, the Ctrl-Alt-Delete key, is transmitted to the virtual machine. Moreover, an arbitrary soft reboot realized by the user of a virtual machine is realized when the administrator terminal 7 of the information processing system sends an email to the user of a virtual machine to request a reboot of the virtual machine and waits for a reboot operation on the user terminal 6 which the user performs at an arbitrary timing.

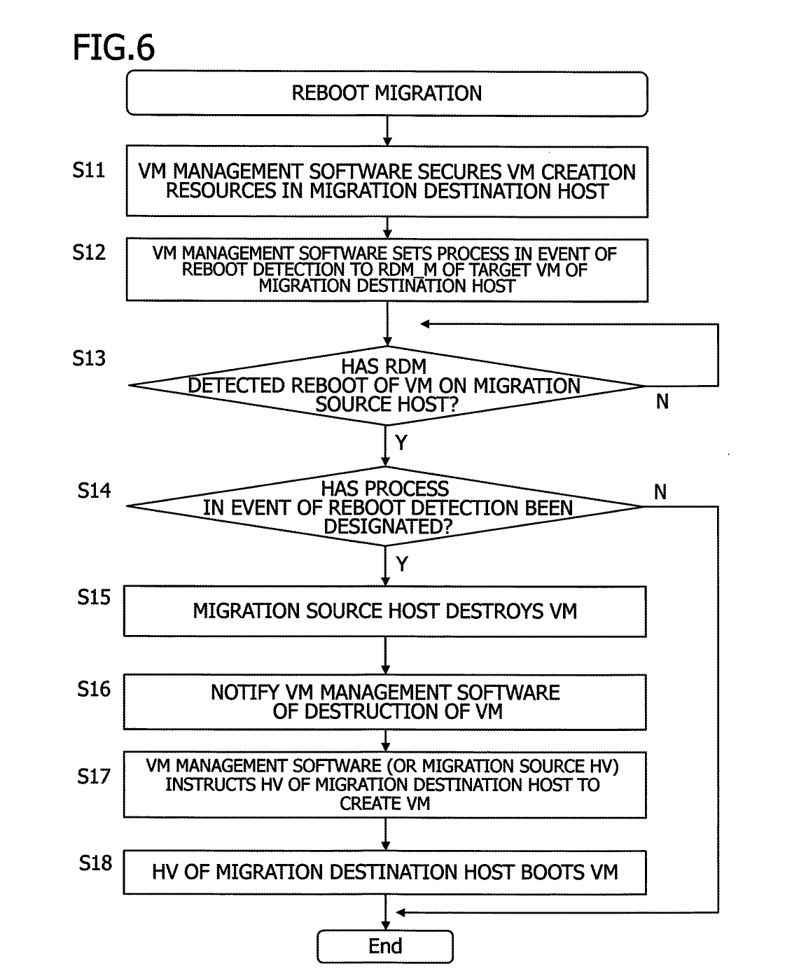

FIG. 6 is a flowchart illustrating a migration process triggered by a reboot in the present embodiment. A migration triggered by a reboot as in the present embodiment is referred to as a reboot migration.

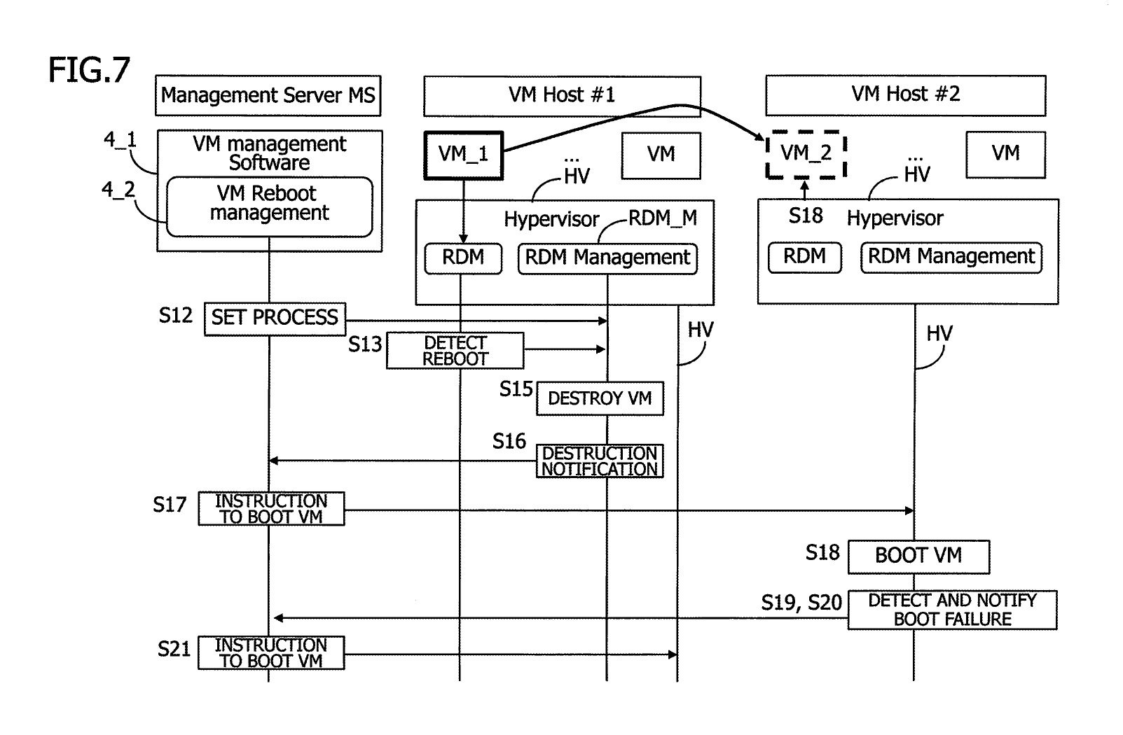

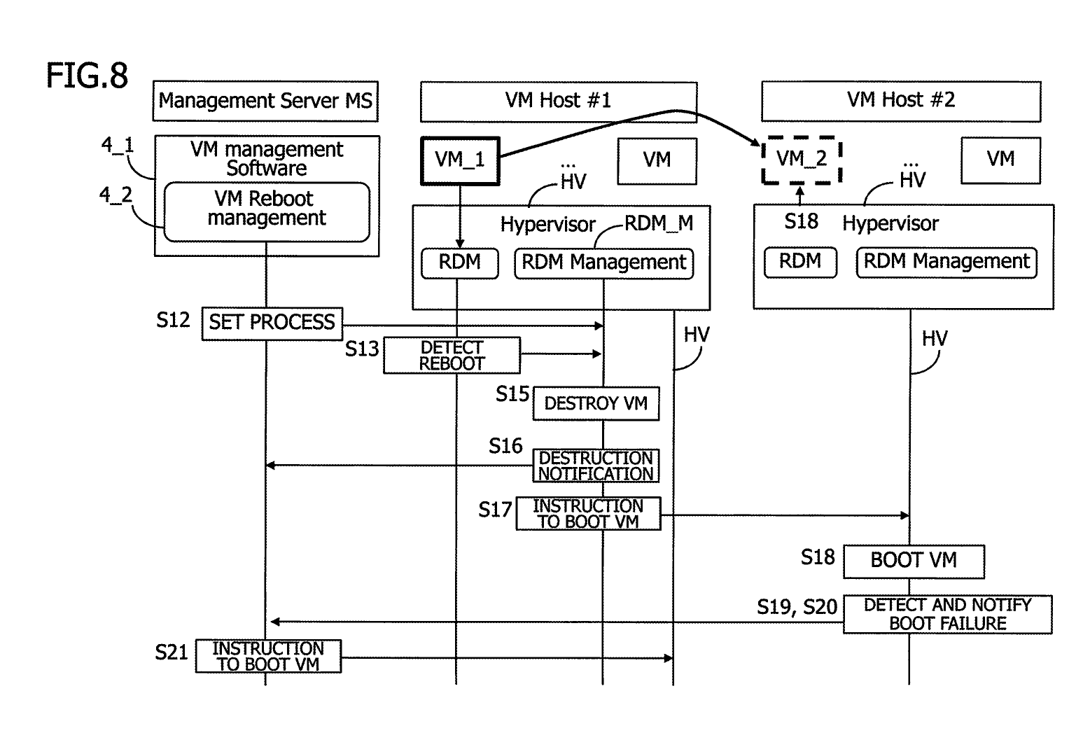

FIGS. 7 and 8 are sequence diagrams illustrating the migration process triggered by a reboot in the present embodiment. In these sequence diagrams, the subjects that execute the processes of the flowchart of FIG. 6 are illustrated. The reboot migration process illustrated in FIG. 6 will be described with reference to FIGS. 7 and 8.

It is assumed that the VM management software 4_1 causes a hypervisor HV of the host 1 to boot a virtual machine VM_1. Moreover, it is assumed that the virtual machine VM_1 on the host 1 migrates to a host 2 for the purpose of maintenance of the host 1 as illustrated in FIGS. 7 and 8.

First, the VM management software 4_1 secures hardware resources, a CPU, a memory capacity, a network bandwidth, and the like needed for creating a virtual machine VM_2 on the migration destination host 2. A specific process of the VM management software 4_1 securing the hardware resources of the virtual machine is the same as that described in step S1 of FIG. 5.

The VM management software 4_1 enables a reboot detection module RDM of the migration target virtual machine VM of the migration source host 1 and sets a process in the event of reboot detection to the RDM management module RDM_M (S12). The process in the event of reboot detection is set in the form of a table in which a flag indicating whether or not to execute a reboot migration in the event of reboot detection, a notification destination IP address to which destruction of the migration target virtual machine VM is notified, an IP address, a port number, and the like of a migration destination virtual machine of the migration destination host are stored in association with all virtual machines VMs.

Thus, when a soft reboot occurs in the virtual machine VM_1 in operation on the host 1, a reboot detection module RDM corresponding to the virtual machine VM_1 detects the soft reboot (S13). The reboot detection module RDM notifies a RDM management module RDM_M of the detection of the soft reboot and causes the RDM management module RDM_M to execute a process to be performed after the detection of the soft reboot.

If the virtual machine VM_1 corresponding to the reboot detection module RDM is a migration target virtual machine, the process to be performed after the detection of the soft reboot has been set to the RDM management module RDM_M. Thus, when the virtual machine VM_1 is not a migration target virtual machine, the process in the event of reboot detection has not been designated to the RDM management module RDM_M (S14: NO), and the process ends with not process executed. On the other hand, when the virtual machine is a migration target virtual machine, since the process in the event of reboot detection has been designated to the RDM management module RDM_M (S14: YES), the virtual machine VM_1 in the migration source host 1 of which the reboot has been detected is destroyed (S15). Moreover, the RDM management module RDM_M notifies the VM management software 4_1 of the destruction of the virtual machine VM_1 (S16). When the virtual machine VM_1 is destroyed, data that needs to be stored such as the data in the memory during operation of the virtual machine VM_1 or the CPU register information is saved in the image file of the shared storage 20.

In the example of FIG. 7, a VM reboot management module 4_2 of the management software 4_1 instructs a hypervisor HV of the migration destination host 2 to boot the virtual machine VM_2 in response to the notification of destruction of the virtual machine VM_1 (S17). In response to this, the hypervisor HV of the migration destination host 2 boots the virtual machine VM_2 based on the configuration information of the migration target virtual machine (S18). The configuration information and the path information of the image file of the virtual machine are attached to an boot command, for example.

On the other hand, in the example of FIG. 8, the RDM management module RDM_M of the hypervisor HV of the migration source host 1 instructs the hypervisor HV of the migration destination host 2 to boot the virtual machine VM_2 (S17). That is, in FIG. 8, rather than the VM reboot management module 4_2 in FIG. 7, the hypervisor HV of the migration source host 1 directly instructs the hypervisor HV of the migration destination host 2 to boot the virtual machine VM_2. In response to this, the hypervisor HV of the migration destination host 2 boots the virtual machine VM_2 based on the configuration information of the migration target virtual machine (S18). The booting the virtual machine includes loading operating system (OS) of the virtual machine in the main memory and booting up the OS to be ready for executing an application program.

In a reboot migration according to the present embodiment, a virtual machine on a migration source host is destroyed using a reboot of a migration target virtual machine as a trigger and thereafter a virtual machine on a migration destination host is booted. Thus, there is no need to transmit data in the memory of a virtual machine in operation from a migration source host to a migration destination host. Further, even when a hypervisor HV of a migration destination host has a different version from a hypervisor of a migration source host, since the migration destination host does not inherit the operation state of the virtual machine on the migration source host, there is little possibility that boot of a virtual machine on the migration destination host fails.

### Modified Example

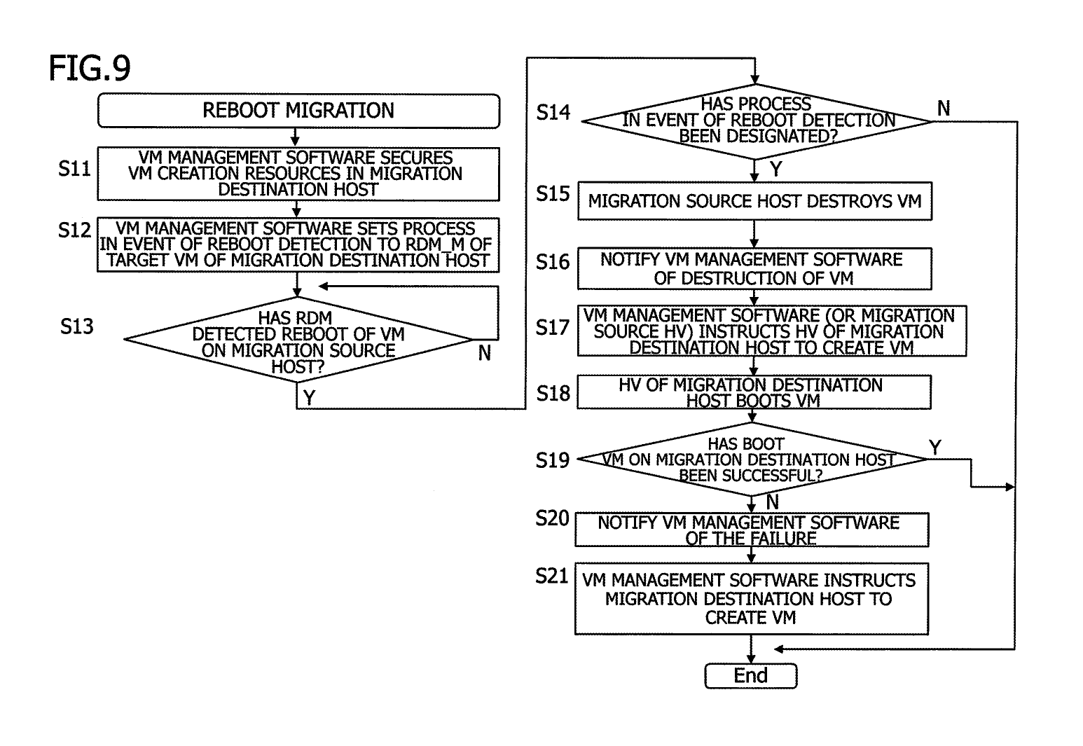

FIG. 9 is a flowchart illustrating a modified example of a migration process triggered by a reboot according to the present embodiment. The processes S11 to S18 illustrated in FIG. 9 are the same as the processes S11 to S18 of FIG. 6. However, in the flowchart of FIG. 9, the processes S19, S20, and S21 are executed subsequently to the process S18 in which the hypervisor HV of a migration destination host boots a virtual machine VM.

That is, after the process S18 of booting the virtual machine VM, the hypervisor HV of the migration destination host 2 checks whether boot of the virtual machine VM on the migration destination host 2 was successful (S19). When the boot has failed due to some reasons, the hypervisor HV of the migration destination host 2 notifies the VM management software 4_1 of the management server 4 of the failure of boot (S20). In response to this notification, the VM management software 4_1 instructs the hypervisor HV of the migration source host 1 to boot the destroyed virtual machine VM so that the virtual machine VM is booted by the hypervisor HV (S21). Since the hypervisor HV is a hypervisor HV of the migration source host 1, there is little possibility that boot of the virtual machine VM fails. However, migration of the migration target virtual machine VM to a migration destination host is not completed.

In FIG. 9, the process S19 of checking whether the hypervisor HV of the migration destination host has successfully booted the virtual machine VM and the processes S20 and S21 performed when the boot has failed are also described in the sequence diagrams of FIGS. 7 and 8.

[Virtual Machine Reboot Detection Process]

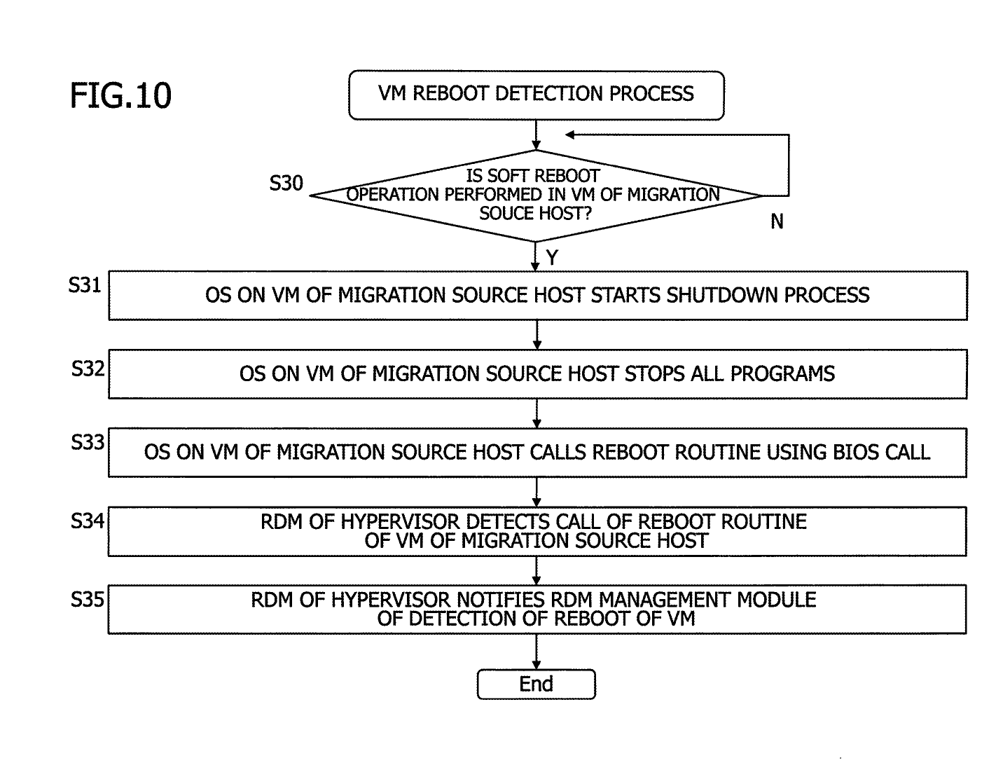

FIG. 10 is a flowchart illustrating a virtual machine reboot operation and a detection process thereof according to the present embodiment. The reboot detection process corresponds to the virtual machine reboot detection process S13 performed by the reboot detection module RDM in FIGS. 6 and 9.

First, when a soft reboot operation is performed in a virtual machine VM of a migration source host (S30: YES), a guest OS on the virtual machine VM starts a process of destroying (shutting down) the virtual machine VM (S31). After the shutdown process starts, the guest OS on the virtual machine VM stops all programs (S32). Further, the guest OS on the virtual machine VM calls a reboot routine using a BIOS call (S33). A reboot detection module RDM of the hypervisor HV of the migration source host detects the call of the reboot routine of the virtual machine VM (S34) and notifies the RDM management module RDM_M of the detection of the reboot of the virtual machine VM (S35).

As described above, according to the present embodiment, by adding a reboot detection module RDM that detects the call of the reboot routine of the virtual machine to the hypervisor HV, a soft reboot of the virtual machine VM is detected.

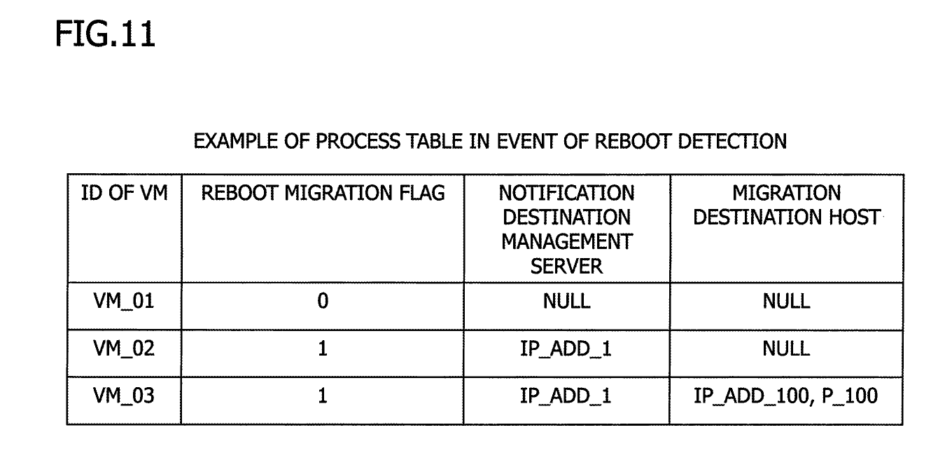

FIG. 11 is a diagram illustrating an example of a process table in the event of reboot detection set to the RDM management module RDM_M according to the present embodiment. In the process table in the event of reboot detection, a reboot migration flag indicating whether or not to execute a reboot migration when a soft reboot is detected, an IP address of the management server 4 to which destruction of a virtual machine VM is notified after the virtual machine VM is destroyed, and an IP address and a port number of the migration destination host are stored in association with the IDs of all virtual machines VMs.

In the process table example illustrated in FIG. 11, since a virtual machine VM_01 is not a migration target virtual machine, the reboot migration flag thereof is set to “0”. Thus, when a soft reboot of the virtual machine VM_01 is detected, the RDM management module RDM_M does not execute a reboot migration process on the virtual machine VM_01 but a hypervisor HV executes a normal reboot process.

On the other hand, since virtual machines VM_02 and VM_03 are migration target virtual machines, the reboot migration flags thereof are set to “1”. Thus, when a soft reboot of the virtual machines VM_02 and VM_03 is detected, the RDM management module RDM_M executes a reboot migration process on the virtual machines VM_02 and VM_03.

Although the IP address of a notification destination management server is set for the virtual machine VM_02, the IP address and the port number of a migration destination host are not set. Thus, when a soft reboot of the virtual machine VM_02 is detected, the RDM management module RDM_M destroys the virtual machine VM_02 and notifies the VM management software 4_1 of the management server 4 of the destruction. In response to this notification, the VM management software 4_1 instructs the hypervisor HV of the migration destination host to boot the virtual machine VM_02 so that the virtual machine VM_02 is booted. That is, the reboot migration process illustrated in FIG. 7 is executed.

On the other hand, the IP address of a notification destination management server and the IP address and the port number of a migration destination host are set for the virtual machine VM_03. Thus, when a soft reboot of the virtual machine VM_03 is detected, the RDM management module RDM_M destroys the virtual machine VM_03 and notifies the VM management software 4_1 of the management server 4 of the destruction. Further, the RDM management module RDM_M instructs a hypervisor HV of the migration destination host to boot the virtual machine VM_03 so that the virtual machine VM_03 is booted. That is, the reboot migration process illustrated in FIG. 8 is executed.

[Migration Triggered by Reboot in Second Embodiment]

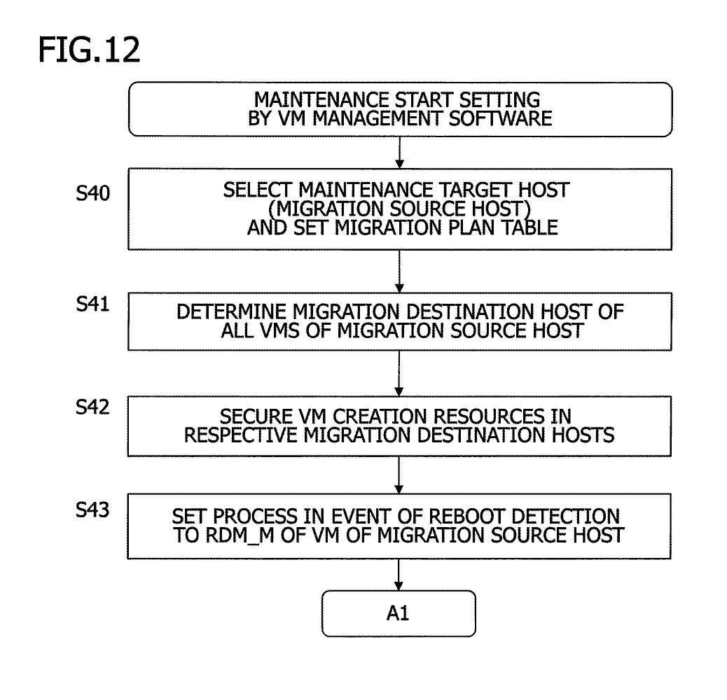

FIGS. 12, 13, and 14 are flowcharts illustrating a migration process triggered by a reboot according to the second embodiment. According to the process of the second embodiment, all virtual machines on a first host migrate to a host other than the first host so as to enable the maintenance of the first host to be performed. In the second embodiment, rather than performing a positive process of prompting a soft reboot of a virtual machine on a first host, a standby is performed until a soft reboot occurs in a virtual machine, and a virtual machine in which a soft reboot has been detected migrates to another host.

FIG. 12 illustrates a maintenance start setting process by the VM management software 4_1. First, in response to an instruction from the administrator terminal 7, the VM management software 4_1 selects a maintenance target host and sets a migration plan table for virtual machines in operation on the maintenance target host (S40).

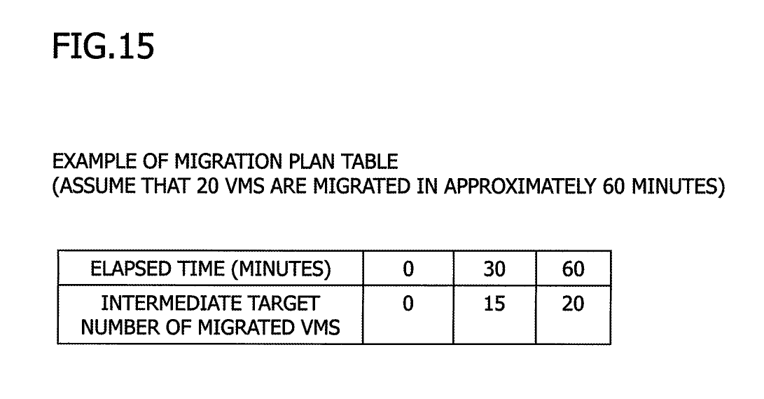

FIG. 15 is a diagram illustrating an example of the migration plan table according to the second embodiment. In this example of the migration plan table, 20 virtual machines VMs in operation on a maintenance target host migrate to another host for approximately 60 minutes. In the migration plan table, the elapsed time from the start of the virtual machine migration process and a target number of migrated virtual machines in each elapsed time are set. In the example of FIG. 15, the target number of virtual machines having migrated in the elapsed time of 30 minutes is set to 15, and the target number of virtual machines having migrated in the elapsed time of 60 minutes is set to 20.

Returning to FIG. 12, the VM management software 4_1 determines a migration destination host of all virtual machines VMs of the migration source host (S41). The VM management software 4_1 detects an appropriate migration destination host for each of the virtual machines VM based on the collected virtual machine information of all hosts. Moreover, the VM management software 4_1 secures hardware resources for creating a virtual machine VM to be migrated in the respective migration destination hosts (S42). The hardware resources to be secured for creating virtual machines have been described above.

Further, the VM management software 4_1 sets the process to be performed after a soft reboot is detected to the RDM management module RDM_M of the hypervisor HV of the migration source host for all virtual machines VMs of the migration source host (S43).

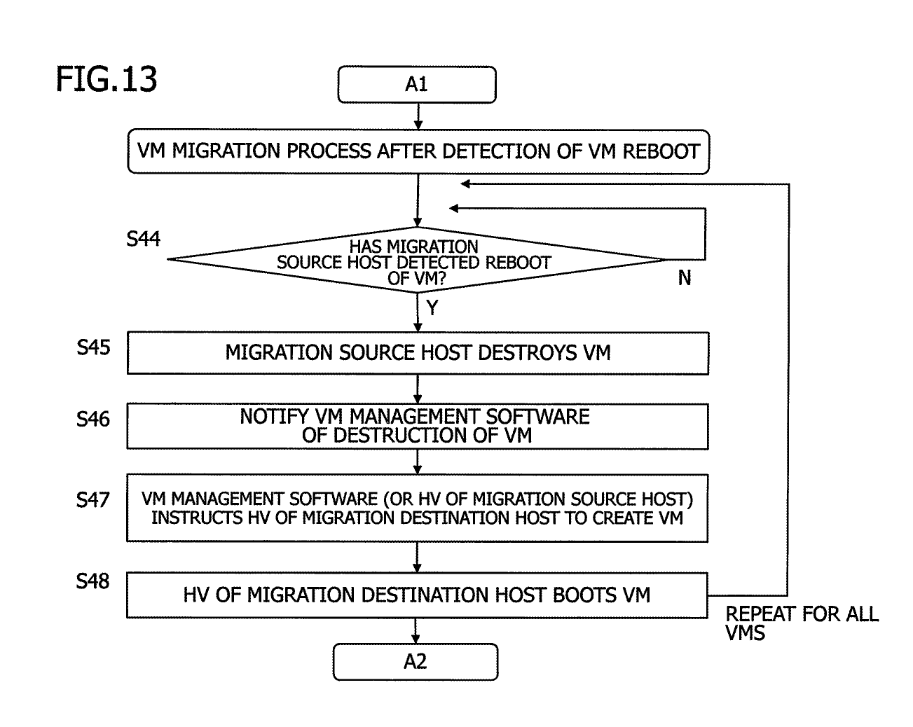

FIG. 13 illustrates a virtual machine VM migration process after a reboot of the virtual machine VM is detected. First, when the reboot detection module RDM of the hypervisor HV of a migration source host detects a soft reboot of a virtual machine (S44: YES), the RDM management module RDM_M having been notified of the reboot detection refers to the process table (FIG. 11) in the event of reboot detection. When the reboot migration flag thereof is “1”, the RDM management module RDM_M destroys the virtual machine VM in the migration source host in which the reboot is detected (S45) and notifies the VM management software 4_1 of the destruction of the virtual machine (S46). In response to the destruction notification, the VM management software 4_1 instructs the hypervisor HV of the migration destination host to boot the virtual machine VM (S47). In response to this boot instruction, the hypervisor HV of the migration destination host boots the destroyed virtual machine VM destroyed in the migration source host (S48). In step S46, the RDM management module RDM_M of the hypervisor HV of the migration source host rather than the VM management software 4_1 may directly instruct the hypervisor HV of the migration destination host to boot the virtual machine VM. The processes S44 to S48 of FIG. 13 are repeated for all virtual machines on the maintenance target migration source host.

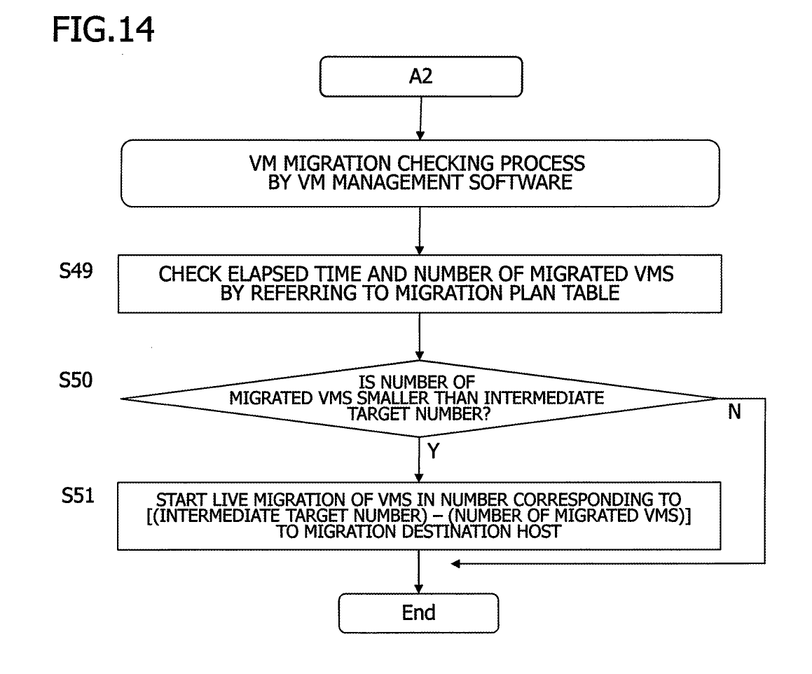

FIG. 14 is a VM migration checking process by the VM management software 4_1. During the repeated processes of S44 to S48 of FIG. 13, the VM management software 4_1 refers to the migration plan table to check the elapsed time and the number of migrated virtual machines (S49). The VM management software 4_1 determines whether the number of migrated virtual machines is smaller than an intermediate target number when the elapsed time reaches 30 minutes (S50). In the migration plan table example of FIG. 15, the intermediate target number at the elapsed time of 30 minutes is 15. If the number of migrated virtual machines is smaller than the intermediate target number, it is highly likely that all 20 virtual machines VMs are not able to be migrated to another host when the elapsed time of 60 minutes expires. Thus, the VM management software 4_1 starts a process of causing a non-migrated virtual machine to live-migrate to a migration destination host (S51). That is, the VM management software 4_1 spontaneously migrates a non-migrated virtual machine to another host based on a live migration without waiting for the occurrence of a soft reboot of the respective virtual machines.

[Migration Triggered by Reboot in Third Embodiment]

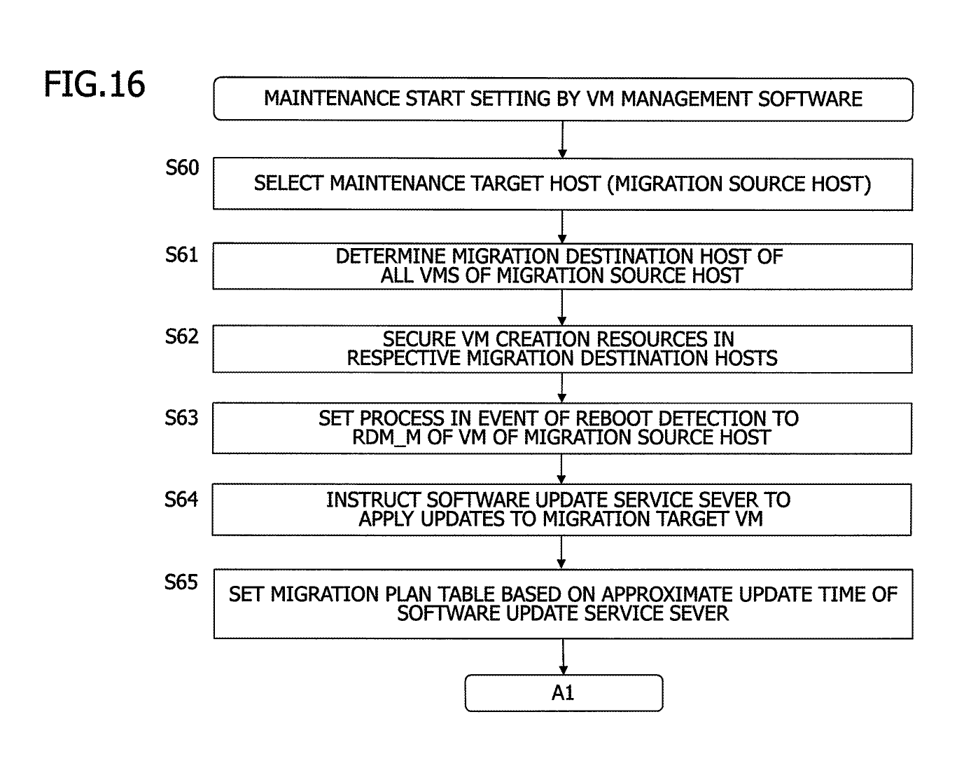

FIGS. 16, 17, and 18 are flowcharts illustrating a migration process triggered by a reboot according to the third embodiment. According to the process of the third embodiment, all virtual machines on a first host migrate to a host other than the first host so that the maintenance of the first host is performed. However, in the third embodiment, a positive process of prompting a soft reboot of a virtual machine on a first host is performed so that the process of migrating virtual machines on the first host is completed as planned. As a positive process of prompting a soft reboot of virtual machines, a notification may be sent to the software update service sever 5 to apply software updates to a migration target virtual machine.

FIG. 16 illustrates a maintenance start setting process by the VM management software 4_1. First, in response to an instruction from the administrator terminal 7, the VM management software 4_1 selects a maintenance target host (S60). The VM management software 4_1 determines a migration destination host of all virtual machines VMs of a migration source host (S61). The VM management software 4_1 detects an appropriate migration destination host for each of the virtual machines VM based on the collected virtual machine information of all hosts. Moreover, the VM management software 4_1 secures hardware resources for creating a virtual machine VM to be migrated into the respective migration destination hosts (S62).

Further, the VM management software 4_1 sets the process to be performed after a soft reboot is detected to the RDM management module RDM_M of the hypervisor HV of the migration source host for all virtual machines VMs of the migration source host (S63).

Subsequently, the VM management software 4_1 instructs the software update service sever 5 to apply software updates to a migration target virtual machine VM (S64). Moreover, the VM management software 4_1 sets a migration plan table based on an approximate update time of the software update service sever 5 (S65). These steps S64 and S65 are different from FIG. 12 in the second embodiment.

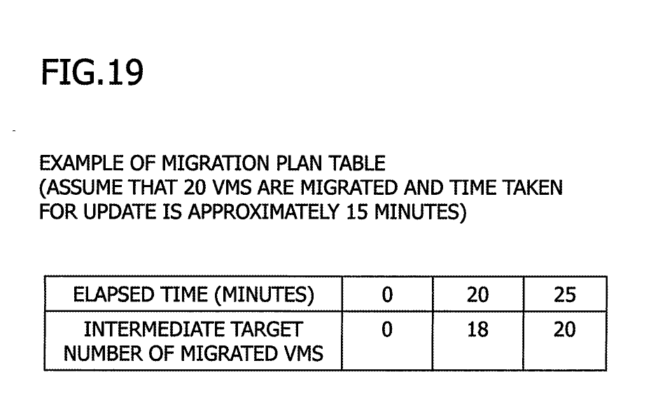

FIG. 19 is a diagram illustrating an example of a migration plan table according to the third embodiment. In this migration plan table, 20 virtual machines VMs are migrated. Moreover, in the migration plan table, an approximate time taken for the updating by the software update service sever 5 is set to approximately 15 minutes, and the number of migrated virtual machines is set to 18 for the elapsed time of 20 minutes and 20 for the elapsed time of 25 minutes.

Although the software update service sever 5 sends a notification to the respective virtual machines to apply updates, the approximate time taken for the updating executed in response to the notification is approximately 15 minutes. Thus, it is expected that a soft reboot occurs 15 minutes after the notification, and migration of most of the virtual machines is completed in the elapsed time of 18 minutes.

However, depending on the usage condition of virtual machines, there is a case in which an update is not executed and a soft reboot operation is not performed after the update. Thus, it is preferable that the VM management software 4_1 checks the number of migrated virtual machines in an intermediate elapsed time, and the VM management software 4_1 causes a hypervisor HV to live-migrate a virtual machine to which the update has not being applied based on a live migration.

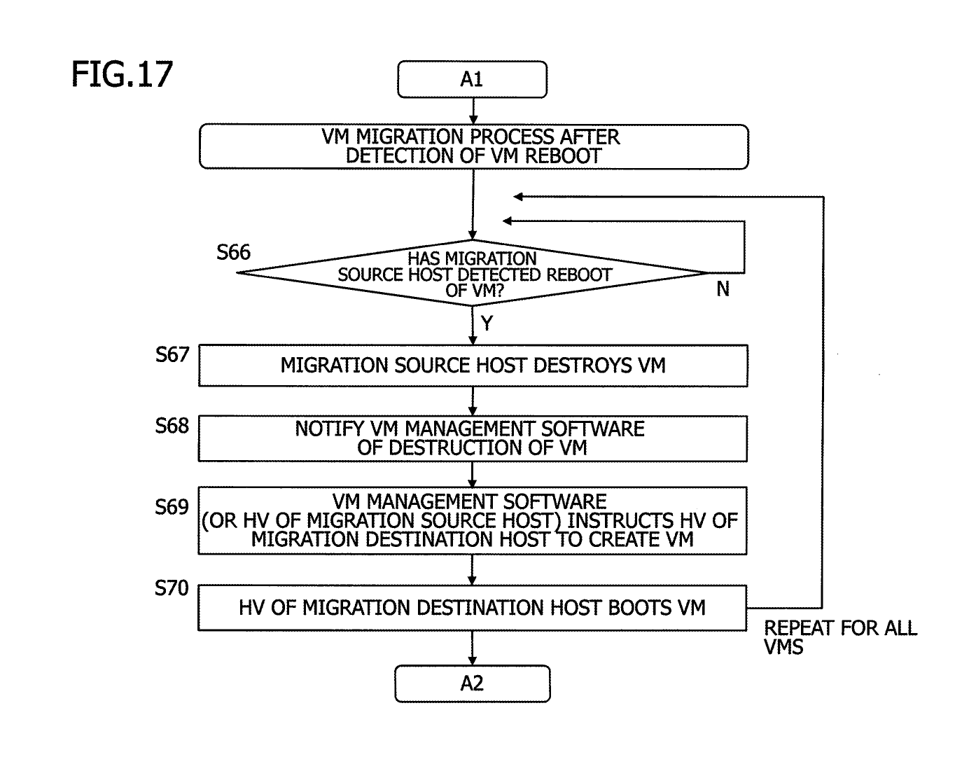

FIG. 17 illustrates a virtual machine VM migration process after a reboot of the virtual machine VM is detected. First, when the reboot detection module RDM of the hypervisor HV of a migration source host detects a soft reboot of a virtual machine (S66: YES), the RDM management module RDM_M having been notified of the reboot detection refers to the process table (FIG. 11) in the event of reboot detection. When the reboot migration flag thereof is “1”, the RDM management module RDM_M destroys the virtual machine VM in the migration source host in which the reboot is detected (S67) and notifies the VM management software 4_1 of the destruction of the virtual machine (S68). In response to the destruction notification, the VM management software 4_1 instructs the hypervisor HV of the migration destination host to boot the virtual machine VM (S69). In response to this boot instruction, the hypervisor HV of the migration destination host boots the migration target virtual machine VM (S70). In step S69, the RDM management module RDM_M of the hypervisor HV of the migration source host rather than the VM management software 4_1 may directly instruct the hypervisor HV of the migration destination host to boot the virtual machine VM. The processes S66 to S70 are repeated for all virtual machines on the maintenance target migration source host.

In the third embodiment, the software update service sever 5 notifies virtual machines on a maintenance target host of application of software updates according to a plan. Thus, it is expected that the virtual machines apply the updates and a soft reboot occurs in the virtual machines unless other special circumstances occur. Therefore, it is expected that a migration target virtual machine is rebooted according to a plan, and using the reboot as a trigger, the migration target virtual machine is destroyed on a migration source host and is booted on another host.

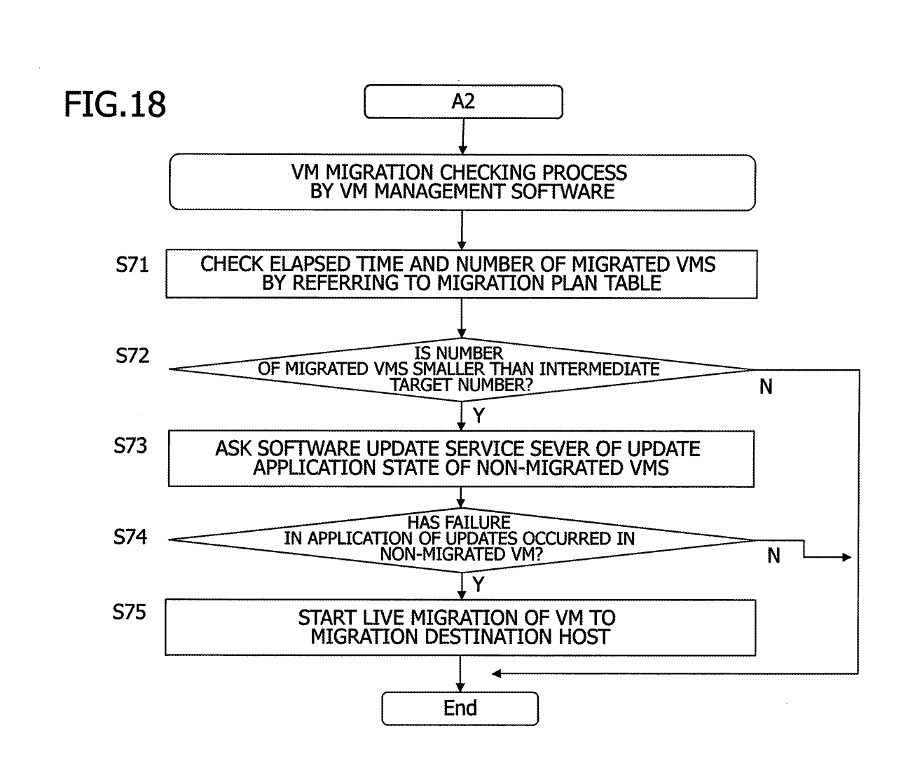

FIG. 18 is a VM migration checking process by the VM management software 4_1. During the repeated processes of S66 to S70 of FIG. 17, the VM management software 4_1 refers to the migration plan table to check the elapsed time and the number of migrated virtual machines (S71). The VM management software 4_1 determines whether the number of migrated virtual machines is smaller than an intermediate target number when the elapsed time reaches 18 minutes (S72). In the migration plan table example of FIG. 19, the intermediate target number in the elapsed time of 18 minutes is 18. If the number of migrated virtual machines is smaller than the intermediate target number, it is expected that the virtual machines in a number corresponding to the difference between the number of migrated virtual machines and the intermediate target number are applying software updates or have not applied or have failed to apply the software updates.

Thus, the VM management software 4_1 asks the software update service sever 5 of an update application state in the non-migrated virtual machine (S73). When the non-migrated virtual machine VM has not applied or has failed to apply the updates (S74: YES), the VM management software 4_1 notifies the hypervisor HV to start a live migration of the virtual machine so that the live migration starts (S75). A The reason why a virtual machine has not applied or has failed to apply the updates may be for example a situation in which a target virtual machine is not able to be soft-rebooted. On the other hand, if the non-migrated virtual machine is applying updates, a standby is performed until the updates are completely applied to the virtual machine.

In the present embodiment, a migration is executed using a soft reboot caused by the user of virtual machines as a trigger. However, a forced reboot of virtual machines caused by an administrator terminal of an information processing system of a server facility, or a soft reboot caused by a user in response to a soft reboot request email sent from the VM management software 4_1 to a user terminal of a virtual machine may be used, in addition to a soft reboot of virtual machines caused by a user terminal of virtual machines.

As described above, according to the migration triggered by a reboot according to the present embodiment, since it is not needed to transmit data in the memory of a migration source host to a migration destination host in the case of live migration, the migration does not need a long period and does not consume a large network bandwidth. Further, even when a hypervisor HV of a migration source host has a different version from a migration destination host, there is little possibility that boot of a virtual machine on the migration destination host fails.

Moreover, according to the migration triggered by a reboot according to the present embodiment, it is possible to control the time to migrate a virtual machine to some extent using an update service provided by a software vendor and to facilitate the planned maintenance of hosts and the host sizing.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a plurality of information processing devices; and
a management device that manages the plurality of information processing devices, wherein
a first information processing device among the plurality of information processing devices includes:
a first booting unit configured to boot a virtual machine;
a reboot detecting unit configured to detect reboot of the virtual machine; and
a destroying unit configured to destroy the virtual machine in response to detection of the reboot, and
a second information processing device among the plurality of information processing devices includes:
a second booting unit configured to boot the destroyed virtual machine upon receiving a boot instruction to boot the destroyed virtual machine after the virtual machine of the first information processing device is destroyed.

2. The information processing system according to claim 1, wherein
the first information processing device further includes a destruction notifying unit configured to transmit a destruction notification indicating that the virtual machine is destroyed, to the management device, and
the management device includes an instructing unit configured to transmit the boot instruction to the second information processing device upon receiving the destruction notification from the first information processing device.

3. The information processing system according to claim 1, wherein
the first information processing device further includes an instructing unit configured to transmit the boot instruction to the second information processing device.

4. The information processing system according to claim 1, wherein
the second information processing device includes:
a failure notifying unit configured to, when the second booting unit fails to boot the destroyed virtual machine, transmit a failure notification indicating that boot of the destroyed virtual machine failed, to the management device, and
the management device includes an instructing unit configured to transmit the boot instruction to the first information processing device upon receiving the failure notification.

5. The information processing system according to claim 1, wherein
the management device includes a setting unit that sets, in the first information processing device, a process in the event of reboot including determining whether or not to destroy the virtual machine when detecting the reboot of the virtual machine.

6. The information processing system according to claim 5, wherein
the process in the event of reboot includes determining whether or not to transmit a boot instruction to boot the destroyed virtual machine to the second information processing device, in addition to determining whether or not to destroy the virtual machine when detecting the reboot of the virtual machine.

7. The information processing system according to claim 1, wherein
the reboot detecting unit of the first information processing device detects reboot of the virtual machine when an operating system of the virtual machine calls a reboot routine using a BIOS call.

8. The information processing system according to claim 1, further comprising:
a software update service device that instructs the virtual machine of the first information processing device to apply a software update at a predetermined timing, wherein
the virtual machine of the first information processing device starts the reboot in response to a reboot operation performed in association with the software update.

9. The information processing system according to claim 1, wherein
the first information processing device further includes a destruction notifying unit configured to transmit a destruction notification indicating that the virtual machine was destroyed, to the management device, and
the management device includes an instructing unit configured to, when a predetermined number of virtual machines among plurality of virtual machines in operation in the first information processing device are not destroyed in a first period, transmit a live migration instruction to the first information processing device to live-migrate the remaining non-destroyed virtual machines of the first information processing device to the second information processing device.

10. A method of controlling an information processing system including a plurality of information processing devices and a management device that manages the plurality of information processing devices, the method comprising:
booting a virtual machine by a first information processing device among the plurality of information processing devices;
detecting reboot of the virtual machine by the first information processing device;
destroying the virtual machine in response to detection of the reboot by the first information processing device; and
booting the destroyed virtual machine upon receiving a boot instruction to boot the destroyed virtual machine after the virtual machine of the first information processing device is destroyed, by a second information processing device among the plurality of information processing devices.

11. The method of controlling an information processing system according to claim 10, further comprising:
transmitting, by the first information processing device, a destruction notification indicating that the virtual machine is destroyed, to the management device, and
transmitting, by the management device, the boot instruction to the second information processing device upon receiving the destruction notification from the first information processing device.

12. The method of controlling an information processing system according to claim 11, further comprising:
transmitting, by the first information processing device, the boot instruction to the second information processing device after the virtual machine is destroyed.

13. An information processing system comprising:
a plurality of information processing devices; and
a management device that manages the plurality of information processing devices, wherein
a first information processing device among the plurality of information processing devices includes:
a first processor; and
a first storage medium storing therein a first program for causing the first processor to execute a first process including,
booting a virtual machine;
detecting reboot of the virtual machine; and
destroying the virtual machine in response to detection of the reboot, and
a second information processing device among the plurality of information processing devices includes:
a second processor; and
a second storage medium storing therein a second program for causing the second processor to execute a second process including,
booting the destroyed virtual machine upon receiving a boot instruction to boot the destroyed virtual machine after the virtual machine of the first information processing device is destroyed.
